(19) United States
(12) Patent Application Publication
(10) Pub. No.: US 2015/0290074 A1
(43) Pub. Date: Oct. 15, 2015

(54) VIBRATING SHOES, VERSION 2

(71) Applicant: Richard Donald Koenig, Merritt Island, FL (US)

(72) Inventor: Richard Donald Koenig, Merritt Island, FL (US)

(73) Assignee: Good Vibrations Shoes Inc., Merritt Island, FL (US)

(21) Appl. No.: 14/250,319

(22) Filed: Apr. 10, 2014

(51) Int. Cl. A61H 23/00; A43B 13/00

(52) U.S. Cl. CPC A61H 23/00; A43B 13/00

(57) ABSTRACT

A vibrating sole device, comprising a vibration unit located within a cavity in a sole, comprising a unitary housing having an interior portion and a heel portion, a vibrator located at the interior portion of the housing, a power supply located at the interior portion of the housing in electrical connection with the vibrator, an actuator for said vibrator in the housing, a status indicator located on the heel portion of the housing, and a power supply port located on the heel portion of the housing.

### CROSS-REFERENCE TO RELATED APPLICATION

This application relates to the same subject matter as co-pending provisional patent application Ser. No. 61/810,394, filed by the same applicant on Apr. 10, 2013. This application claims the Apr. 10, 2013 filing date as to the common subject matter.

### BACKGROUND

1. Field of Invention

This invention relates to shoes and devices with health improving features for those persons who experience cold, tired and achy feet along with persons to whom stimulation to the balance sensing nerve organs would be a benefit. The invention is an improved way to bring comfort to the mentioned conditions, with the advantage of portability while allowing ambulation.

2. Related Art

Persons that stand for long periods or walk excessive distance during a normal day are subject to tired, achy feet which may be compounded by swelling. Traditionally, these persons will desire the removal of their shoes at the earliest opportunity. Often they have soaked their feet and massaged them to reduce discomfort.

Thereafter, inventors created various whirlpool bath machines that allowed water to be swirled causing a massaging effect on the foot. Other portable machines warmed water or allowed warm water to be kept warm while having a vibrating action employed to bring comfort. Still other machines had a vibrating platform with which to apply the feet, for the same desired effect. The difficulty with each modality is the lack of portability, the machines being cumbersome and heavy, especially those that are filled with water. Vibrating machines are heavy to move, difficult to store and require that the user be stationary during therapy sessions.

The Medicare Therapeutic Shoe Bill was passed in 1993. This bill permits health care professionals to prescribe or supply special shoes and orthotic inserts to eligible diabetic patients. The purpose of the bill and the shoes issued under the bill is to reduce the incidence of diabetic foot complications, including ulcerations and amputations.

Persons who have experienced sore muscles of the foot during and after activity, who may have cold, clammy feet or swelling of the feet after prolonged sitting and standing often seek foot massage and vibrators applied to the feet. U.S. Pat. No. 7,152,345 to Koenig teaches a vibrating shoe without a unitary housing. Homedics manufactures a vibrating slipper that should not be worn outside of the home. Whole body vibrating platforms have been well studied and some of the manufactures include G Power, Life Span and Health Mark. All of the aforementioned products are not practical for an active lifestyle or appropriate in the workplace. In addition they are very expensive and occupy an unreasonable amount of space.

Accordingly, the objects and advantages of the present invention include: (a) a comfortable shoe that appears to be acceptable footwear for workplace or leisure wear; (b) an integrated vibration mechanism that has been incorporated into the heel and arch of shoes; (c) vibrating shoes that may be worn anywhere, anytime; (d) a vibration unit which may be turned on and off at will; (e) a power supply such as one or more batteries that is permanently installed into the unit and rechargeable; (f) preprogrammed vibration patterns, including one that has four cycles and is randomized; (g) shoes made of high quality leather with a supple full lining made of a material such as pigskin; (h) a charging mechanism such as one that is “matched charge” so that the need for charge decreases as the batteries are charging up; (i) an indicator or signal light which indicates charging status; (j) an indicator light which changes color when the battery is fully charged; (k) outsoles made of a long lasting, durable material; (l) outsoles having a tread design which is slip resistant; (m) a USB or similar port for recharging the battery so the battery may be charged from a wall outlet or from a computer or computer battery for travel; (n) the unit is sealed with a gasket or similar device or material to prevent moisture from entering the electronics.

### SUMMARY OF THE INVENTION

The objects and advantages of the present invention include: (a) lightweight construction of the therapeutic vibrating shoe; (b) portability of having a soothing modality included in a shoe; (c) mobility for the person using the Therapeutic Vibrating Shoe; (d) availability of therapy in transit, as in riding in a car or flying on an airplane; (e) available options for the user to remain seated with feet elevated or dependent, reclining, supine, prone or ambulatory while soothing vibration is experienced but feet are enclosed and thus body warmth is preserved; and (f) inexpensive, modular construction.

Thus the reader will see that the invention has great value to the wearer in terms of comfort, usefulness, style and therapeutic benefit. Said invention is reliable, effective, unobvious and of great value. The present invention allows therapy to the common complaint of foot ache, while not encumbering the wearer to be non-active. The wearer can choose when and where he/she receives therapy for foot discomfort. The present invention, with the exception of the minimal controls well disguised in the rear of the heel of the shoes, appear as regular high quality, dress, casual and athletic shoes.

### BRIEF DESCRIPTION OF THE DRAWINGS

FIG. 1 is a perspective view of one embodiment of the inventive device.

FIG. 2 is a detail perspective view of one embodiment of the inventive device.

FIG. 3A is a perspective view of a vibration unit of one embodiment of the inventive device.

FIG. 3B is a perspective view of a deployed vibration unit of one embodiment of the inventive device.

FIG. 3B is a perspective view of a deployed vibration unit of one embodiment of the inventive device.

FIG. 4A is a top view of the housing of one embodiment of the inventive device.

FIG. 4B is a side cutaway view of the housing of one embodiment of the inventive device.

FIG. 4C is a second side view of the housing of one embodiment of the inventive device.

FIG. 4D is a perspective view of the housing of one embodiment of the inventive device.

FIG. 4E is a front view of the housing of one embodiment of the inventive device.

FIG. 5 is a perspective view of the vibration unit of one embodiment of the inventive device without a cover.

FIG. 6 is a perspective view of a cover plate for one embodiment of the inventive device.

### DETAILED DESCRIPTION OF THE INVENTION

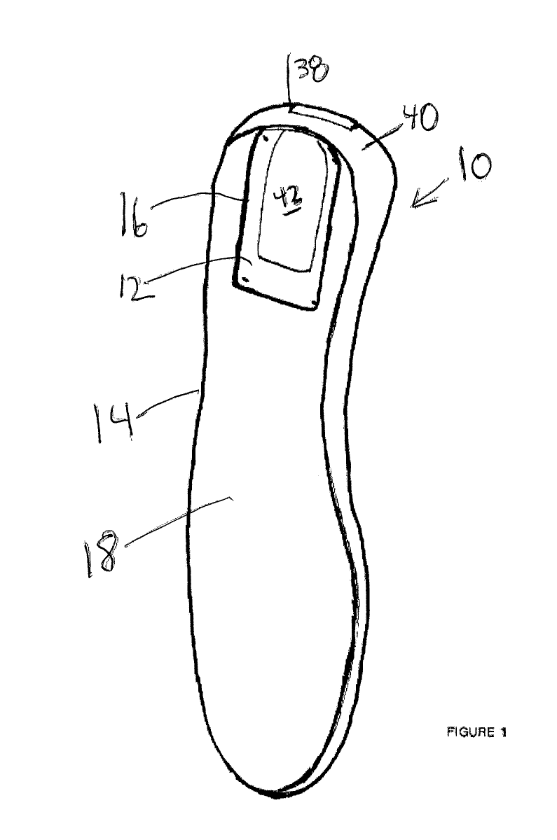

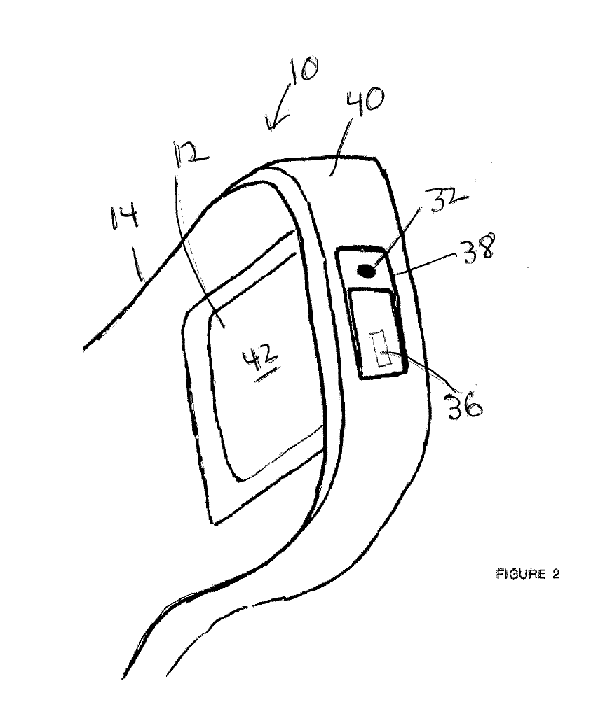

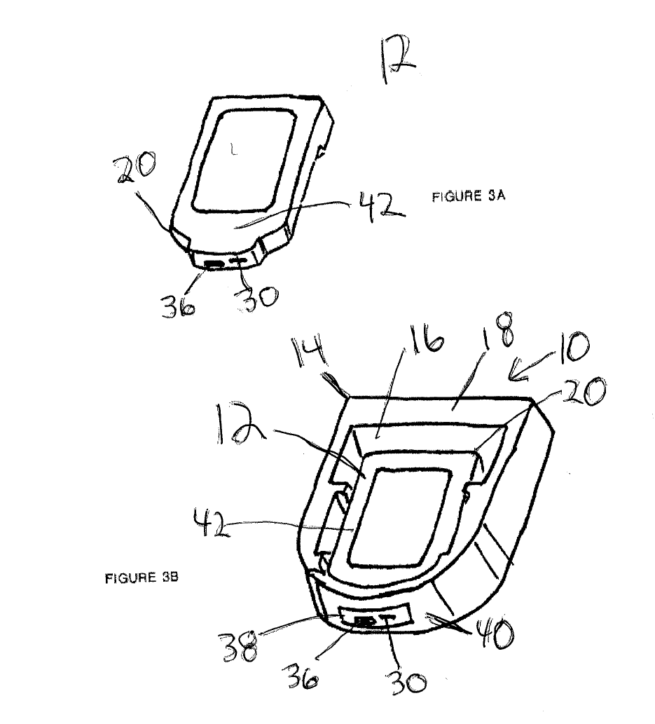

The present invention is a vibrating sole device, shown at 10 in FIGS. 1 through 4. The device comprises a vibration unit 12. The vibration unit 12 may be located in a sole 14 at a cavity 16 on the top surface 18 of the sole 14.

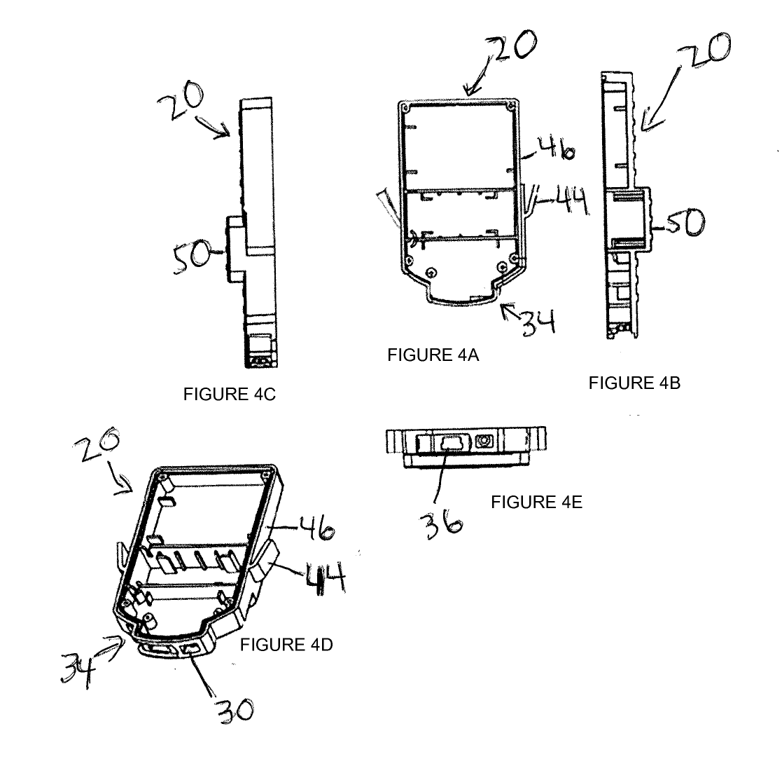

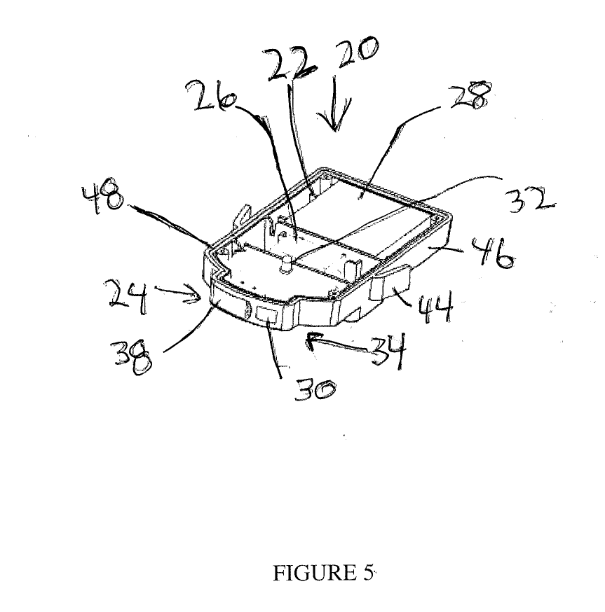

The vibration unit 12 includes a unitary housing 20 shown in FIGS. 4 and 5. The housing 20 includes an interior portion 22 and a heel portion 24. A vibrator 26 is located in the interior portion 22 of the housing 20. The vibrator may be a vibrating motor, and may have a frequency of about 5000 revolutions per minute.

A power supply 28 in direct or indirect electrical connection with the vibrator 26 is located in the interior portion 22 of the housing 20. An actuator 30 for the vibrator 26 such as a switch is also located at the interior portion 22 of the housing 20. The actuator 30 could be a push button or a sliding switch. The actuator 30 is directly or indirectly electrically coupled to the vibrator 26. In addition, the device 10 includes a status indicator 32 located on the heel portion 34 of the housing 20. In one embodiment, the actuator 30 is translucent or transparent so that the status indicator 32 may be viewed through the actuator 30. Also, a power supply port 36 located on the heel portion 24 of the housing 20 is in direct or indirect electrical connection with the power supply 28. The power supply port 36 may be protected with a power supply port cover 38 and made of an appropriate material such as plastic. Also, the power supply port 36 and the actuator 30 may be accessible through a void 38 in the heel portion 40 of the sole 14.

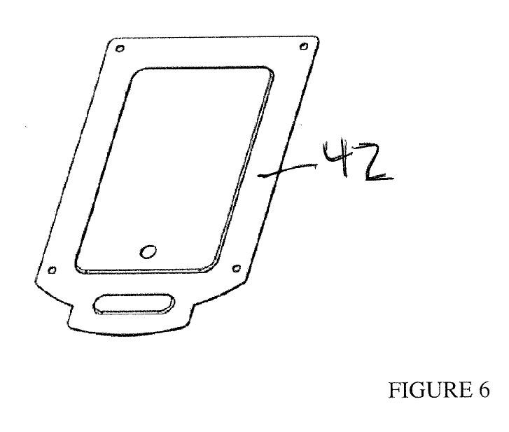

In addition, the housing 20 may include a cover plate 42 as shown in FIG. 6. The cover plate 42 may be made of metal or plastic or some other protective material known in the art. The cover plate 42 may be permanently attached to the housing 20 to protect the elements within the interior portion 22 of the housing 20. Alternatively, the cover plate 42 may be removably attached on the housing 20 by screw, clips or other mechanisms known in the art. Also, the cover plate 42 may be movably attached to the housing 20 so that the cover plate 42 remains attached to the housing 20 while still enabling access to the interior portion 22 of the housing 20. For example, the cover plate 42 may pivot or slide across the cavity 16.

In one embodiment shown in FIG. 5, the device 10 includes a seal 48 such as a gasket or an application of a sealing material located in the interior portion of the housing. This seal allows the elements within the interior portion of the housing to be better protected.

The housing 20 may also include one or more flanges 44 located in the outer surface 46 of the housing 20. The flange 44 is just one contemplated means for locking the housing 20 in place within the cavity 16 of a sole 14.

In one embodiment, the status indicator 32 is an LED. The LED may have more than one color to indicate charging status, charge level of the power supply, or provide other indications regarding the operation of the device 10.

The power supply port 36 may be any type known in the art, such as a USB port, a mini USB port, a micro USB port or a DC adapter port. The power supply may be a battery such as a 3.7V lithium battery.

In addition, the actuator 30 may be activated with a remote control. The remote control may be hand held or attached to a piece of jewelry such as a bracelet or necklace.

The vibration unit 12 of the device 10 may be programmed for one or more preprogrammed vibration settings.

In addition, as shown in FIG. 4, the housing 20 may include a projection 50. The projection 50 may allow for improved performance of the vibrator during operation.

Preprogrammed vibration programs may be made part of the device. For example, once the device is started the vibration may be a steady, comfortable 60 Hz cycle for 2 minutes and then begin 4 patterns of interrupted vibration. When completed, the pattern may return to a steady 2 minute vibration and may begin the pattern again randomly. The wearer can be seated, standing or walking, participating in his/her daily activities. Vibration passes into the feet, first a steady 60 Hz, then after 2 minutes a pattern of vibration commences for 4-5 minutes and returns to the steady vibration, to repeat the cycles, randomly. The small musculature in the feet increases activity from the vibration, thus pushing the lactic acid of muscle fatigue out while demanding more circulation. The result is a warming through muscle activity. The wearer can control the duration of vibration to tolerance or preference. One embodiment may be capable of continuous use for approximately 20 hours before needing recharge.

The invention is used as follows. Vibrating shoes, or shoes with the vibrating soles, or vibrating inserts in the soles of the shoes are placed on feet and activated. A switch in the rear of heel may be pushed on to start, or a remote control may activate the device.

This form of foot comfort is portable, allowing movement while receiving this treatment. In addition, the vibrating shoes can be used while riding in a car, airliner and other forms of travel. The vibration is personal and will not disturb others in a public place therefore can be used during long waiting in transportation terminals; it is self-contained and does not require hook-ups, so the user is free to move about; it does not require water in a basin as a vehicle to translate vibration into the foot and is therefore not messy or dangerous; it does not require AC or DC current to power the vibrator source and is therefore portable and useable in any environment; it is contained within the confines of a soft shoe with a semi-firm sole and therefore maintains body warmth and uses the body warmth to augment soothing treatment; it employs inexpensive parts and technology therefore making this form of treatment, inexpensive and affordable.

Although the description above contains many specifics, these should not be construed as limiting the scope of the invention but as merely providing illustrations of some of the embodiments of this invention. For example, the shoe can have other shapes such as a broader, less contoured sole and closure configurations such as elastic strap closure instead of hook and loop strap closure.

Thus the scope of the invention should be determined by the appended claims and their legal equivalents, rather than by the examples given.

What is claimed is:

1. A vibrating sole device, comprising:
a sole having a top surface and a heel surface, said top surface including a cavity;
a vibration unit located within said cavity; said vibration unit comprising:
a unitary housing having an interior portion and a heel portion;
a vibrator located at the interior portion of the housing;
a power supply located at the interior portion of the housing, said power supply in electrical connection with said vibrator;
an actuator for said vibrator located at the interior portion of the housing, said actuator being electrically coupled to said vibrator;
a status indicator located on the heel portion of the housing; and
a power supply port in electrical connection with the power supply located on the heel portion of the housing.

2. The device of claim 1, wherein the housing further comprises a moveably attached plate covering the cavity.

3. The device of claim 1, wherein the housing further comprises a removable plate covering the cavity.

4. The device of claim 1, wherein the housing further comprises at least one flange located on an outer surface of the housing.

5. The device of claim 1, wherein the status indicator is an LED.

6. The device of claim 1, wherein the power supply port is one of a USB port, a mini USB port, a micro USB port, and a DC adapter port.

7. The device of claim 1, wherein the vibration unit is programmed for at least one vibration setting.

8. The device of claim 1, wherein the power supply comprises a 3.7V lithium battery.

9. The device of claim 1, wherein the actuator is activated with a remote control.

10. The device of claim 2, further comprising a sealing gasket located in the interior portion of the housing.

11. The device of claim 3, further comprising a sealing gasket located in the interior portion of the housing.

12. A vibrating shoe, comprising:
A sole having a top surface and a heel surface, said top surface including a cavity;
a vibration unit located within said cavity; said vibration unit comprising:
a unitary housing having an interior portion and a heel portion;
a vibrator located at the interior portion of the housing;
a power supply located at the interior portion of the housing, said power supply in electrical connection with said vibrator;
an actuator for said vibrator located at the interior portion of the housing, said actuator being electrically coupled to said vibrator;
a status indicator located on the heel portion of the housing; and
a power supply port in electrical connection with the power supply located on the heel portion of the housing.

13. A shoe vibration insert, comprising:
a vibration unit comprising:
a unitary housing having an interior portion and a heel portion;
a vibrator located at the interior portion of the housing;
a power supply located at the interior portion of the housing, said power supply in electrical connection with said vibrator;
an actuator for said vibrator located at the interior portion of the housing, said actuator being electrically coupled to said vibrator;
a status indicator located on the heel portion of the housing; and
a power supply port in electrical connection with the power supply located on the heel portion of the housing.
